(19) United States
(12) Patent Application Publication
(10) Pub. No.: US 2016/0297256 A1
(43) Pub. Date: Oct. 13, 2016

(54) Tire Accessory Device

(71) Applicant: Gamini Sudasinghe, Staten Island, NY (US)

(72) Inventor: Gamini Sudasinghe, Staten Island, NY (US)

(21) Appl. No.: 15/098,004

(22) Filed: Apr. 13, 2016

Related U.S. Application Data
(60) Provisional application No. 62/146,482, filed on Apr. 13, 2015.

(51) Int. Cl. B60C 13/00; B32B 37/12; B60C 13/04

(52) U.S. Cl. CPC B60C 13/001; B60C 13/04; B32B 37/1284; B32B 2451/00; B32B 2605/08; B32B 2605/18; B32B 2605/00

(57) ABSTRACT

A tire accessory device for creating a white wall on a vehicle wheel assembly is provided. The vehicle wheel assembly includes a wheel having a rim with a tire positioned about the rim. The tire accessory device comprises an annular member having a front side surface, a rear side surface opposite the front side surface, an inner edge, and an outer edge opposite the inner edge. An adhesive layer is applied to the rear side surface of the annular member. Upon positioning the rear side surface of the annular member against the tire, the adhesive layer causes the annular member to adhere to the tire thereby creating a customized white wall tire.

### CLAIM OF PRIORITY

This patent application claims priority under 35 USC 119 (e) (1) from U.S. Provisional Patent Application Ser. Number 62/146,482 filed Apr. 13, 2015, of common inventorship herewith entitled, “White Wheels,” which is incorporated herein by reference as though the same were set forth in its entirety.

### FIELD OF THE INVENTION

The present invention pertains to the field of vehicular tires, and more specifically to the field of decorative walled tires.

### BACKGROUND OF THE INVENTION

Automobile owners spend a lot of time driving on the road. Many motorists want their vehicles to reflect style and comfort. Some people add decorative accents to their vehicles that are visually appealing while conveying their personal interest and individuality. An extremely popular way in which people revamp the overall appearance of their cars, trucks and vans is by installing a new set of tires. Produced in a variety of styles such as mag wheels, low profile wheels, whitewashed wheels and modular wheels, a clean, new set of tires can vastly improve the appearance of any automobile. Many car enthusiasts agree that tires are a crucial element to the overall appearance and function of their automobile, but color options for tires are surprisingly limited to basic black. As many automobile aficionados spend a great deal of time and money customizing their vehicles, it is unfortunate that tires are virtually identical in every vehicle on the road.

The prior art has put forth several designs for decorative walled tires. Among these are:

U.S. Pat. No. 3,508,595 to Richard B. Wilson describes a sidewall protective cover for tires that has very good processing characteristics during the fabrication of a tire and outstanding resistance to weather and abrasion. This protective cover layer resides over the unexposed portion of a decorative, sidewall for a tire. The layer contains a blend of between approximately ten and thirty parts of ethylene propylene terpolymer, forty and sixty parts of natural rubber, and twenty and fifty parts of chlorobutyl rubber. The protective layer is applied over the decorative strip during the tire building operation. After the tire is cured, a portion of said layer is removed to expose a part of the decorative strip.

U.S. Pat. No. 3,449,201 to Jonnes Nelson and Philip V. Palmquist describes materials and procedures for forming facings on tire sidewalls at the place of sale of the tire. In this procedure for decorating tires, stock in only one kind of tire for each grade and size is maintained. This tire is sold as a black wall tire, or it is provided with a variety of sidewall facings including white facings, facings colored other than white such as the color of the automobile on which the tires are to be placed, and facings that provide a reflex reflective sidewall. The novel sidewall facings are easily applied in a short time by the service personnel of a retail tire operation.

U.S. Pat. No. 3,164,192 to Rosa Martinez De Garcia and Jose Kasio describes a pneumatic tire having a removable sidewall covering capable of being applied to or removed from said tire without having to disassemble the vehicle wheel. For this purpose, at least one of the tire sidewalls is provided with a male or female coupling means arranged and located so as to match a complementary female or male coupling means provided on the inner face of the sidewall covering, whereby the simple inter fitting of said male and female coupling means will define the face to face mounting of the covering to the tire sidewall.

None of these prior art references describe the present invention.

### SUMMARY OF THE INVENTION

It is an object of the present invention to provide a line of adhesive strips that fit around the exterior of car wheels, instantly rendering tires as white walled tires.

The present invention is a tire accessory device for creating a white wall on a vehicle wheel assembly. The vehicle wheel assembly includes a wheel having a rim with a tire positioned about the rim. The tire accessory device comprises an annular member having a front side surface, a rear side surface opposite the front side surface, an inner edge; and an outer edge opposite the inner edge. An adhesive layer is applied to the rear side surface of the annular member. Upon positioning the rear side surface of the annular member against the tire, the adhesive layer causes the annular member to adhere to the tire thereby creating a customized white wall tire.

In addition, the present invention includes a method for creating a white wall on a vehicle wheel assembly. The vehicle wheel assembly includes a wheel having a rim with a tire positioned about the rim. The method comprises providing an annular member having a front side surface, a rear side surface opposite the front side surface, an inner edge, and an outer edge opposite the inner edge, applying an adhesive layer to the rear side surface of the annular member, positioning the rear side surface of the annular member against the tire, causing the adhesive layer of the annular member to adhere to the tire, and creating a customized white wall tire.

The present invention further includes a tire accessory device for creating a white wall effect. The tire accessory device comprises a vehicle wheel assembly including a wheel having a rim with a tire positioned about the rim. An annular member is provided having a front side surface, a rear side surface opposite the front side surface, an inner edge, and an outer edge opposite the inner edge, an inner diameter of the annular member being greater than or equal to an inner diameter of the tire and an outer diameter of the annular member being less than or equal to an outer diameter of the tire. An adhesive layer is applied to the rear side surface of the annular member. A removable cover is releasably positionable over the adhesive layer. Upon positioning the rear side surface of the annular member against the tire, the adhesive layer causes the annular member to adhere to the tire thereby creating a customized white wall tire.

### BRIEF DESCRIPTION OF THE DRAWINGS

FIG. 1 is a perspective view illustrating an automobile tire prior to installing a tire accessory device, constructed in accordance with the present invention.

FIG. 2 is a perspective view illustrating the automobile tire of FIG.

1 subsequent to installing the tire accessory device, constructed in accordance with the present invention.

FIG. 3 is a front perspective view illustrating an annular member of the tire accessory device, constructed in accordance with the present invention.

FIG. 4 is a rear perspective view illustrating the annular member of the tire accessory device, constructed in accordance with the present invention, with an adhesive applied to the annular member for adhering to a front facing side of an automobile tire.

FIG. 5 is a sectional view illustrating the tire accessory device, constructed in accordance with the present invention, with a removable cover covering the adhesive layer.

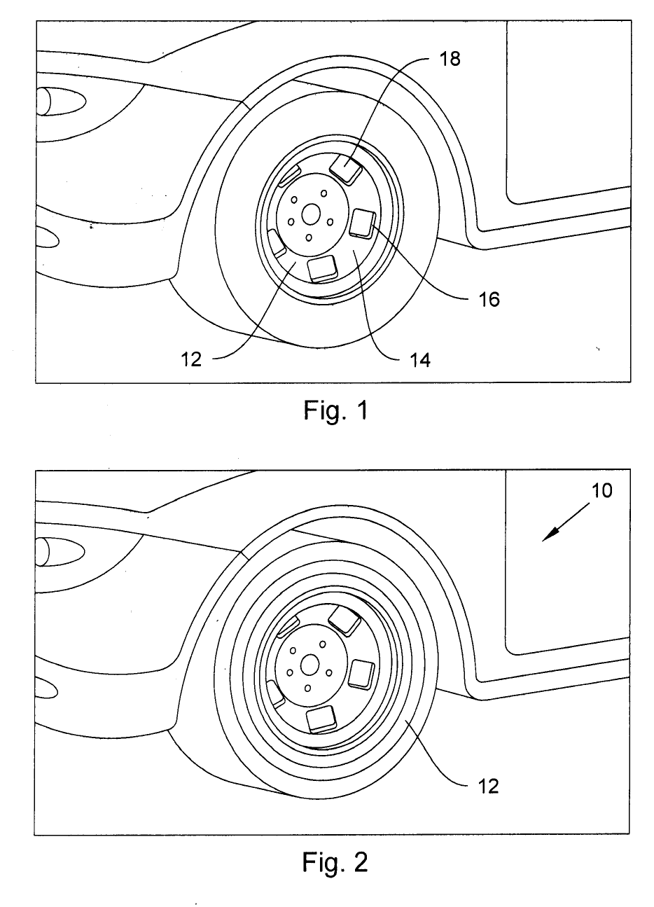

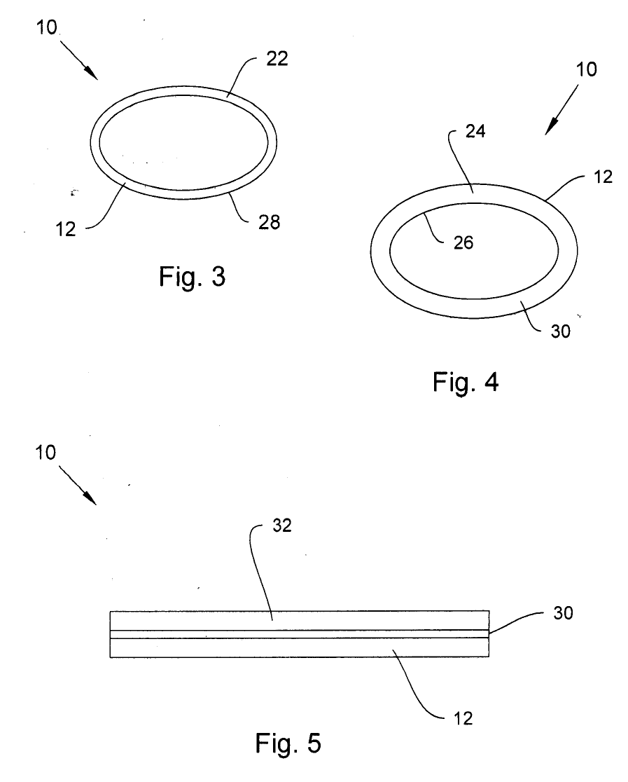

### DETAILED DESCRIPTION OF THE INVENTION

The present invention, hereinafter referred to as a Tire Accessory Device, indicated generally at 10, is a line of annular adhesive rings configured to fit on the tire 18 of a vehicle wheel assembly 12, that instantly renders the tires 18 as eye popping white wall tires. For purposes of discussion and the present application, the vehicle wheel assembly 12 includes a wheel 14 having a rim 16 with the tire 18 positioned about the rim 16. The rim 16 is the outer edge of the wheel 12 and holds the tire 18 in position about the wheel 14.

It should be noted that while the Tire Accessory Device 10 will be described and illustrated as being applied to an automobile tire 18 of a vehicle wheel assembly 12, it is within the scope of the present invention to apply the Tire Accessory Device 10 to any type of vehicle tire 18 including, but not limited to, trucks, bicycles, motorcycles, airplanes, etc. As such, the Tire Accessory Device 10 harkens back to a time when most vehicles sported the sleek white wall look which was prevalent many years ago rather than the almost all exclusively wheeled black tires of today. Basically, the Tire Accessory Device 10 provides motorists with a means if customizing their tires 18.

The Tire Accessory Device 10 of the present invention is an annular member 20 having a front side surface 22, a rear side surface 24 opposite the front side surface 22, an inner edge 26, and an outer edge 26 opposite the inner edge 28. Presented in a full circular shape, the annular member 20 is preferably constructed from a durable rubber material although constructing the annular member 20 from another type of material is within the scope of the present invention.

The annular member 20 of the Tire Accessory Device 10 of the present invention preferably measures approximately one and one-half (1½″) inches to two and one-half (2½″) inches in width between the inner edge 26 and the outer edge 28 and approximately one eighth (⅛″) inch in thickness between the front side surface 22 and the rear side surface 24. It should be noted that while the preferred measurements of the annular member 20 are set forth above, it is within the scope of the present invention for the measurements of the annular member 20 to be greater or less than those above depending on the size and type of tire 18 and the desires of the user. Also, it is preferable that an inner diameter of the annular member 20 is greater than or equal to an inner diameter of the tire 18 and/or an outer diameter of the annular member 20 is less than or equal to an outer diameter of the tire 18 such that the annular member 20 does not overlap either the rim 16 of the wheel assembly 12 and/or the outer edge of the tire 18.

In addition, the annular member 20 of the Tire Accessory Device 10 of the present invention can be constructed in a variety of sizes to accommodate various sized tire walls. Since most automobile tires fall within a certain measurement range, preferably, the annular member 20 for an automobile tire 18 measures between approximately thirteen (13″) inches and seventeen (17″) inches although constructing the annular member 20 in different sizes is within the scope of the present invention.

The Tire Accessory Device 10 of the present invention additionally includes an adhesive layer 30 applied to the rear side surface 28 of the annular member 20. Preferably, the adhesive layer 30 is a durable glue adhesive that withstands the elements as well as the wear and tear of vehicle operation although constructing the adhesive layer 30 from other adhesive materials is within the scope of the present invention.

In a preferred embodiment of the Tire Accessory Device 10 of the present invention, a removable cover 32 can be releasably positioned over the adhesive layer 30 which, when removed, exposes the adhesive layer 30. The removable cover 32 protects the integrity of the adhesive layer 30 and inhibits the adhesive layer 30 from sticking to unintended objects. It should be noted that instead of the removable cover 32, the adhesive layer 30 could actually be a fluid activated adhesive or other mechanism for adhesive activation to activate the adhesive properties of the adhesive layer 30.

Use and application of the Tire Accessory Device 10 of the present invention is very simple and straightforward. First, the user acquires a set of annular members 20 to be applied to the vehicle tire 18. Removing the cover 32 and exposing the adhesive layer 30, the user centers the annular member 20 over the vehicle tire 18. With the annular member 20 centered, the user positions the annular member 20 such that the inner edge 26 of the annular member 20 is beyond the inner edge of the vehicle tire 18 and/or the outer edge 28 of the annular member 20 is within the outer edge of the vehicle tire 18. As such, the annular member 20, with the adhesive layer 30, is swiftly and durably adhered to the outside tire walls 18 by any skilled auto lover.

A line of sturdy, durable tire adornments manufactured in a crisp white hue, the Tire Accessory Device 10 of the present invention appeal to virtually any automobile owner who appreciates vehicle appeal as well as automotive history. Available in sets of four annular members 20 to fully outfit all of the tires 18 of a passenger vehicle, motorists apply a set of annular members 20 of the Tire Accessory Device 10 to set their vehicles apart from other vehicles on the road by displaying eye catching alternatives to standard black tires. A versatile concept, augmented Tire Accessory Devices 10 also are applicable and striking on both motorcycles and even bicycles, lending these two wheelers a snappy appearance that is sure to appeal to those riders. Durably constructed and reasonably priced, the Tire Accessory Device 10 will withstand many years of use for auto enthusiasts everywhere.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claim.

1. A tire accessory device for creating a white wall on a vehicle wheel assembly, the vehicle wheel assembly includes a wheel having a rim with a tire positioned about the rim, the tire accessory device comprising:
an annular member having a front side surface, a rear side surface opposite the front side surface, an inner edge, and an outer edge opposite the inner edge; and
an adhesive layer applied to the rear side surface of the annular member;
wherein upon positioning the rear side surface of the annular member against the tire, the adhesive layer causes the annular member to adhere to the tire thereby creating a customized white wall tire.

2. The tire accessory device of claim 1 wherein the annular member is constructed from a durable rubber material.

3. The tire accessory device of claim 1 wherein an inner diameter of the annular member is greater than or equal to an inner diameter of the tire.

4. The tire accessory device of claim 1 wherein an outer diameter of the annular member is less than or equal to an outer diameter of the tire.

5. The tire accessory device of claim 1 wherein an inner diameter of the annular member is greater than or equal to an inner diameter of the tire and an outer diameter of the annular member is less than or equal to an outer diameter of the tire.

6. The tire accessory device of claim 1 wherein the adhesive layer is a durable glue adhesive.

7. The tire accessory device of claim 1 and further comprising:
a removable cover releasably positionable over the adhesive layer.

8. The tire accessory device of claim 7 wherein the removable cover protects the integrity of the adhesive layer and inhibits the adhesive layer from sticking to unintended objects.

9. The tire accessory device of claim 1 wherein the vehicle wheel is selected from the group consisting of an automobile wheel, a motorcycle wheel, a bicycle wheel, and an airplane wheel.

10. A method for creating a white wall on a vehicle wheel assembly, the vehicle wheel assembly includes a wheel having a rim with a tire positioned about the rim, the method comprising:
providing an annular member having a front side surface, a rear side surface opposite the front side surface, an inner edge, and an outer edge opposite the inner edge;
applying an adhesive layer to the rear side surface of the annular member;
positioning the rear side surface of the annular member against the tire;
causing the adhesive layer of the annular member to adhere to the tire; and
creating a customized white wall tire.

11. The method of claim 10 and further comprising:
releasably positioning a removable cover over the adhesive layer; and
removing the removable cover prior to positioning the annular member to the tire.

12. The method of claim 10 and further comprising:
creating an inner diameter of the annular member greater than or equal to an inner diameter of the tire; and
creating an outer diameter of the annular member less than or equal to an outer diameter of the tire.

13. A tire accessory device for creating a white wall effect, the tire accessory device comprising:
a vehicle wheel assembly including a wheel having a rim with a tire positioned about the rim;
an annular member having a front side surface, a rear side surface opposite the front side surface, an inner edge, and an outer edge opposite the inner edge, an inner diameter of the annular member being greater than or equal to an inner diameter of the tire and an outer diameter of the annular member being less than or equal to an outer diameter of the tire;
an adhesive layer applied to the rear side surface of the annular member; and
a removable cover releasably positionable over the adhesive layer;
wherein upon positioning the rear side surface of the annular member against the tire, the adhesive layer causes the annular member to adhere to the tire thereby creating a customized white wall tire.

14. The tire accessory device of claim 13 wherein the annular member is constructed from a durable rubber material.

15. The tire accessory device of claim 13 wherein the adhesive layer is a durable glue adhesive.

16. The tire accessory device of claim 13 and further comprising:
a removable cover releasably positionable over the adhesive layer.

17. The tire accessory device of claim 16 wherein the removable cover protects the integrity of the adhesive layer and inhibits the adhesive layer from sticking to unintended objects.

18. The tire accessory device of claim 13 wherein the vehicle wheel is selected from the group consisting of an automobile wheel, a motorcycle wheel, a bicycle wheel, and an airplane wheel.
